(19) United States
(12) Patent Application Publication
(10) Pub. No.: US 2023/0146500 A1
(43) Pub. Date: May 11, 2023

(54) SYSTEMS AND METHODS FOR DETERMINING AN OPTIMAL PLACEMENT OF A PACKAGE

(71) Applicant: HERE GLOBAL B.V., Eindhoven (NL)

(72) Inventors: Donta White, Racine, WI (US); LEON STENNETH, Chicago, IL (US); Adekunle Afolabi, Aurora, IL (US)

(73) Assignee: HERE GLOBAL B.V., Eindhoven (NL)

(21) Appl. No.: 17/524,440

(22) Filed: Nov. 11, 2021

(51) Int. Cl. G06Q 10/08

(52) U.S. Cl. CPC G06Q 10/08355; G06Q 10/0838

(57) ABSTRACT

Systems and methods for determining an optimal placement of a package at a location are provided. For example, a method for determining an optimal placement of a package at a location includes determining a first area for placement of a package at a location based on historical delivery data. The method also includes determining a second area for placement of the package at the location based on map data. The method also includes determining an optimal area for placement of the package at the location based on the first area and the second area.

### TECHNICAL FIELD

The present disclosure relates generally to delivery of packages, and more specifically to systems and methods for determining an optimal placement of a package at a location.

### BACKGROUND

When a package being transported by a person, autonomous ground vehicle, drone, etc., reaches its destination and there is no one available to receive the package, any number of problems may ensue. In some instances, the package might be stolen, damaged, or destroyed. In some cases where there is no interaction between a person delivering a package and a person receiving the package, the package is placed in any area without consideration of any factors. In some locations, this manner of delivering packages is not sustainable. Crimes of opportunity, insurance claims, loss of time, logistics planning, etc., are some of the problems that may result from the lack of optimal placement of package at a location.

### BRIEF SUMMARY

The present disclosure overcomes the shortcomings of prior technologies. In particular, a novel approach for determining an optimal placement of a package at a location is provided, as detailed below.

In accordance with an aspect of the disclosure, a method for determining an optimal placement of a package at a location is provided. The method includes determining a first area for placement of a package at a location based on historical delivery data. The method also includes determining a second area for placement of the package at the location based on map data. The method also includes determining an optimal area for placement of the package at the location based on the first area and the second area.

In accordance with another aspect of the disclosure, an apparatus is provided. The apparatus includes a processor. The apparatus also includes a memory comprising computer program code for one or more programs. The computer program code is configured to cause the processor of the apparatus to receive traffic data corresponding to a location. The computer program code is further configured to cause the processor of the apparatus to based on the traffic data, determine an optimal area for placement of a package at the location. The computer program code is further configured to cause the processor of the apparatus to provide an instruction for placement of the package at the optimal area at the location.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device to receive a request to a deliver a package at a location. The one or more instructions further cause the device to determine an optimal area for delivery of the package based on a maximum field of view of the location. The one or more instructions further cause the device to provide an instruction for delivering the package at the optimal location. Also, a computer program product may be provided. For example, a computer program product comprising instructions which, when the program is executed by a computer, cause the computer to carry out the steps described herein.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of determining an optimal placement of a package at a location, in accordance with aspects of the present disclosure;

FIG. 2 is a diagram illustrating an example scenario for determining an optimal placement of a package, in accordance with aspects of the present disclosure;

FIG. 3 is a diagram illustrating another example scenario for determining an optimal placement of a package, in accordance with aspects of the present disclosure;

FIG. 4 is a diagram illustrating an example location for delivering a package, in accordance with aspects of the present disclosure;

FIG. 5A is a diagram illustrating an example scenario for determining an optimal placement of a package at the example location of FIG. 4, in accordance with aspects of the present disclosure;

FIG. 5B is a diagram illustrating another example scenario for determining an optimal placement of a package at the example location of FIG. 4, in accordance with aspects of the present disclosure;

FIG. 6 is a diagram of a geographic database, in accordance with aspects of the present disclosure;

FIG. 7 is a diagram of the components of a data analysis system, in accordance with aspects of the present disclosure;

FIG. 8 is a flowchart setting forth steps of an example process, in accordance with aspects of the present disclosure;

FIG. 9 is a flowchart setting forth steps of another example process, in accordance with aspects of the present disclosure;

FIG. 10 is a flowchart setting forth steps of another example process, in accordance with aspects of the present disclosure;

FIG. 11 is a diagram of an example computer system, in accordance with aspects of the present disclosure;

FIG. 12 is a diagram of an example chip set, in accordance with aspects of the present disclosure; and

FIG. 13 is a diagram of an example mobile device, in accordance with aspects of the present disclosure.

### DESCRIPTION OF SOME EMBODIMENTS

Examples of a method, a non-transitory computer-readable storage medium, and an apparatus for determining an optimal placement of a package at a location are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

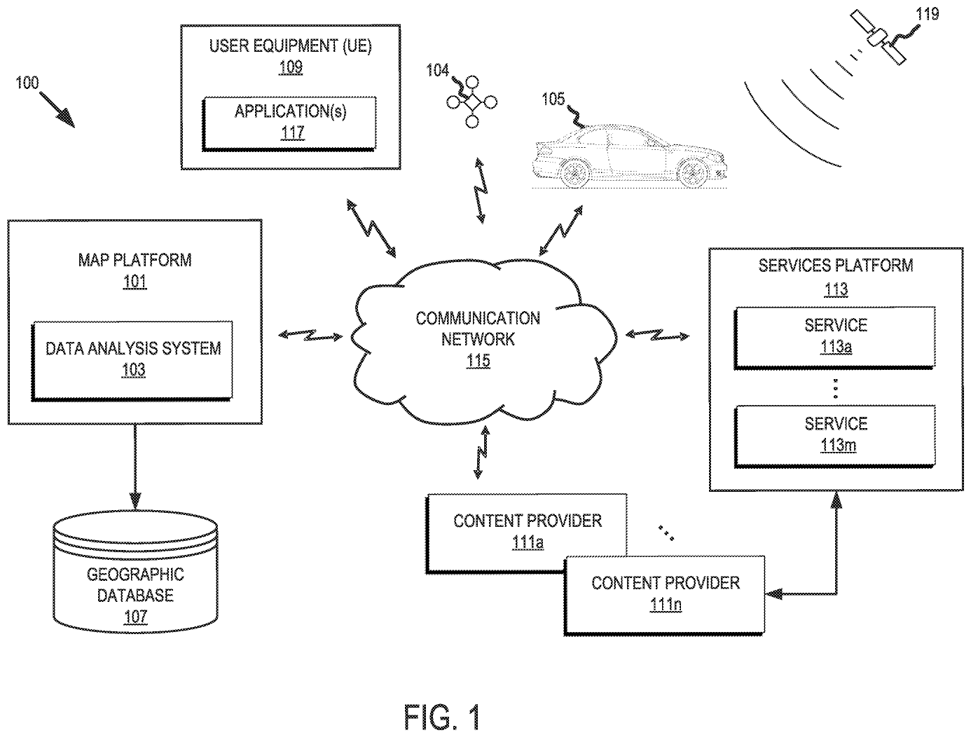

FIG. 1 is a diagram of a system 100 capable of determining an optimal placement of a package, according to one embodiment. The system 100 enables a delivery person approaching the location associated with the delivery of the package to strategically place the package in an area where the package will receive the best visibility, until it is retrieved by an authorized individual, and best capture the profile of an unauthorized individual (e.g., a thief) and/or an authorized individual (e.g., the intended recipient) who eventually retrieves the package.

The system 100 of FIG. 1 introduces a capability to determine a first area for placement of the package at the location based on historical delivery data. In one example, the historical delivery data includes instructions from an occupant of the location. In another example, the historical delivery data includes information about one or more previous delivery attempts of a package. In one example, the historical data includes indexed data from three-dimensional (3D) models, information provided by third parties, and through other means used for delivering one or more packages. The system 100 can determine a second area for placement of the package at the location based on map data. In one example, the map data includes various map elements included in one or more maps. In one example, the map data may include features of houses or infrastructure including the position and quantity of cameras associated with a structure. For example, via map data, the system 100 can determine how many cameras are in an area or at a certain location and/or the associated field of view. The system 100 can determine an optimal area for placement of the package at the location based on the first area and the second area. In one embodiment, determining the optimal area for placement of the package includes an analysis of the first area and the second area. In one embodiment, the analysis also includes the value of the cargo, the package weight, the estimated time the package will be unattended, the end-customer expected time of arrival, the speed limit of vehicular traffic associated with the location, the amount of pedestrian traffic associated with the location, cameras in the area, the time of day, the position of the sun, and other inputs. In another embodiment, more or less inputs can be included in the analysis.

Referring to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for determining an optimal placement of a package at a location or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for determining an optimal placement of a package at a location, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in determining an optimal placement of a package at a location according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

In one embodiment, the drone 104 is equipped with logic, hardware, firmware, software, memory, etc. to collect, store, and/or transmit data measurements from their respective sensors continuously, periodically, according to a schedule, on demand, etc. In one embodiment, the logic, hardware, firmware, memory, etc. can be configured to perform all or a portion of the various functions associated with determining an optimal placement of a package at a location according to the various embodiments described herein. The drone 104 can also include means for transmitting the collected and stored data over, for instance, the communication network 115 to the map platform 101 and/or any other components of the system 100 for determining an optimal placement of a package at a location and/or initiating navigational services or other map-based functions based on determining an optimal placement of a package at a location.

In one embodiment, the drone 104 is an unmanned aerial vehicle (UAV). The UAV may be configured to operate in one or more modes (e.g., an autonomous mode or a semi-autonomous mode). In one example, the UAV may be configured to sense its environment or operate in the air without a need for input from an operator, among others. In another example, the UAV may be controlled by a remote human operator, while some functions are carried out autonomously. Further, the UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another, while the UAV's navigation system autonomously controls more fine-grained navigation decisions, such as the specific route to take between the two locations, specific flight controls to achieve the route and avoid obstacles while navigating the route, and so on. It is envisioned that other examples are also possible. By way of example, a drone can be of various forms. For example, a drone may take the form of a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, and/or an ornithopter, among other possibilities.

In one embodiment, drones can be associated other vehicles (e.g., connected and/or autonomous cars). These other vehicles equipped with various sensors can act as probes traveling over a road network within a geographical area represented in the geographic database 107. Accordingly, the drone volatility indices generated from data sensed from locations along the road network can be associated with different areas (e.g., map tiles, geographical boundaries, etc.) and/or other features (e.g., road links, nodes (intersections), POIs) represented in the geographic database 107. Although the vehicles are often described herein as automobiles, it is contemplated that the vehicles can be any type of vehicle, manned or unmanned (e.g., planes, aerial drone, boats, etc.). In one embodiment, the drone 104 is assigned a unique identifier for use in reporting or transmitting data and/or related probe data (e.g., location data).

In one embodiment, the vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. In another example, the vehicle 105 may be an autonomous vehicle. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input).

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move packages between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for determining an optimal placement of a package at a location. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with determining an optimal placement of a package at a location, either alone or in combination with the data analysis system 103.

In some embodiments, the UE 109, the drone 104, and/or the vehicle 105 may include various sensors for acquiring a variety of different data or information. For instance, the UE 109, the drone 104, and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109, the drone 104, and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109, the drone 104, and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109, the drone 104, and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109, the drone 104, and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6, and layer 7) headers as defined by the OSI Reference Model.

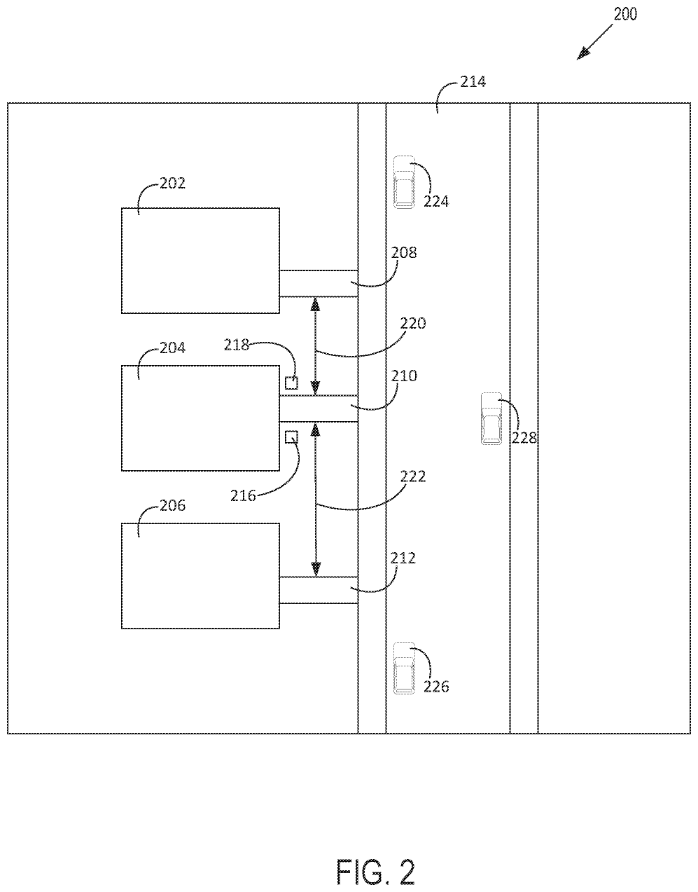

FIG. 2 is a diagram illustrating an example scenario for determining an optimal placement of a package. The scenario 200 includes a top view of a house 202, a house 204, and house 206, a road segment 214, and vehicle 224, a vehicle 226, and a vehicle 228. As shown in FIG. 2, the house 202 is associated with a walkway 208, the house 204 is associated with a walkway 210, and the house 206 is associated with a walkway 212.

In one embodiment, the system 100 of FIG. 1 is configured to determine a first area for placement of a package at a location based on historical delivery data. In this embodiment, the system 100 is configured to determine a second area for placement of the package at the location based on map data. Continuing with this embodiment, the system 100 is configured to determine an optimal area for placement of the package at the location based on analysis of the first area and the second area.

In one example, the system 100 of FIG. 1 is configured to determine the area 216 for placement of a package at the house 204 based on historical delivery data. In this example, the system 100 is also configured to determine the area 218 for placement of a package at the house 204 based on map data. Continuing with this example, the system 100 is configured to determine an optimal placement of the package at the house 204 based on an analysis of the area 216 and the area 218.

In one example, the historical delivery data for the house 204 includes images and/or text pertaining to previous delivered packages. For example, the system 100 of FIG. 1 may receive images captured by one or more individuals working for one or more delivery companies that have delivered packages at the house 204. In one example, the system 100 may receive text corresponding to instructions for previous delivered packages at the house 204. In one example, the system 100 may receive contextual data from one or more drones that delivered one or more packages at the house 204. In another example, the system 100 may receive video captured by a camera (not shown) affixed to the house 204 that includes an approach used by an individual or a drone that delivered a package.

In one example, the map data used to determine the second area 218 for placement of the package at house 204 includes one or more features associated with the house 204. In one example, the system 100 of FIG. 1 may be configured to calculate the distance 220 between the walkway 208 and the walkway 210. In this example, the system 100 may also be configured to calculate the distance 222 between the walkway 210 and the walkway 212. Continuing with this example, the system 100 may determine that the distance 222 is greater than the distance 220. Based on a greater distance 222, the system 100 may determine that the second area 218 is the optimal area for placement of the package based on the proximity to the walkway 208.

In one example, the system 100 of FIG. 1 may be configured to analyze a field of view associated with a package placed at either the first area 216 or the second area 218 based on the determined distances 220 and 222. For example, the system 100 may determine that there is a higher likelihood that an individual associated with the house 202 could have a greater field of view of the package if it is placed in the area 218 compared to a field of view of an individual associated with the house 206 and placement of the package at the area 216. Continuing with this example, the system 100 may determine that the optimal area for placement of the package is in the second area 216 based on greater field of view from the house 202. In another example, the system 100 may be configured to analyze other features associated with any of the houses 202-206 for determining the optimal area for placement of the package. For example, if there are one or more obstructions (e.g., a fence, trees, bushes, etc.) between the houses 202 and 204, then despite the closer proximity between the walkways 208 and 210, the field of view associated with an individual from the house 202 could be severely impacted by the one more obstructions. In this example, the system 100 may be configured to determine the optimal area for placement of the package is in the first area 216 despite the greater distance between the walkways 210 and 212.

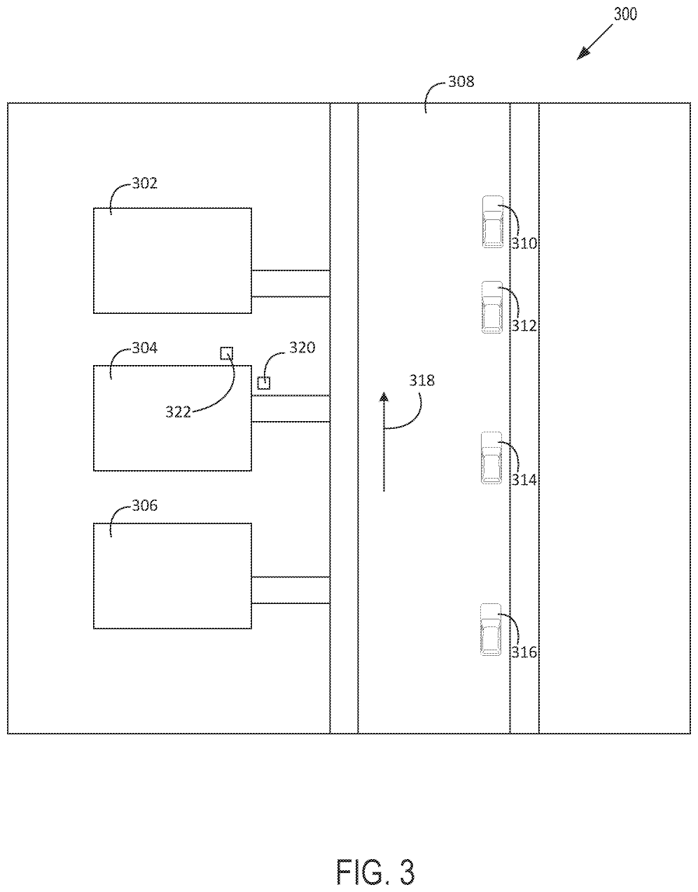

FIG. 3 is a diagram illustrating an example scenario for determining an optimal placement of a package. The scenario 300 includes a top view of a house 302, a house 304, and house 306, a road segment 308, a vehicle 310, a vehicle 312, a vehicle 314, and a vehicle 316.

In one embodiment, the system 100 of FIG. 1 is configured to receive traffic data corresponding to a location. In this embodiment, the system 100 is configured to, based on the traffic data, determine an optimal area for placement of the package at the location. Continuing with this example, the system 100 is configured to provide an instruction for placement of the package at the optimal area at the location.

In one example, the system 100 of FIG. 1 is configured to receive traffic data corresponding to the house 304. As shown, in FIG. 3, all the vehicles 310-316 are parked on one side of the road segment 308. In this example, based on there being no vehicles parked on the left side of the road segment 308, the system 100 may be configured to receive information about an increase or decrease in traffic associated with the road segment 308. In one example, the decrease in traffic may lead to other vehicles travelling down the road segment 308 at a higher speed than when there are vehicles parked on both sides of the road segment 308. In one scenario, that may allow an unauthorized individual to arrive and depart from a location along the road segment 308 with one or more stolen packages from the houses 302-306.

In one example, the system 100 of FIG. 1 is configured to, based on the traffic data, determine an optimal area for placement of a package at the house 304. In one example, the system 100 may have previously determined a first area 320 for placement of a package at the house 304. However, based on the traffic data, the system 100 is configured to determine an optimal second area 322 for placement of the package at the location. In one scenario, one or more unauthorized individuals may not be able to see the package placed in the second area 322 as they drive down the road segment 308 along a direction 318 versus if the package is placed at the first area 320. In this scenario, the package placed at the optimal second area 322 may have a better chance of not being stolen based on a reduced ability to view the package by an individual traveling along the road segment 308.

In one example, the system 100 of FIG. 1 is configured to provide an instruction for placement of the package at the determined optimal second area 322 at the house 304. In one example, the instruction may be displayed on a user interface of an application (e.g., application(s) 117 of FIG. 1) used for delivering packages. In another example, the instruction may be provided to a drone for delivering a package and include coordinates corresponding to the second area 322. In another example, the instruction may be provided to an electronic device (e.g., UE 109 of FIG. 1) associated with the delivery of packages and carried by an individual delivering packages.

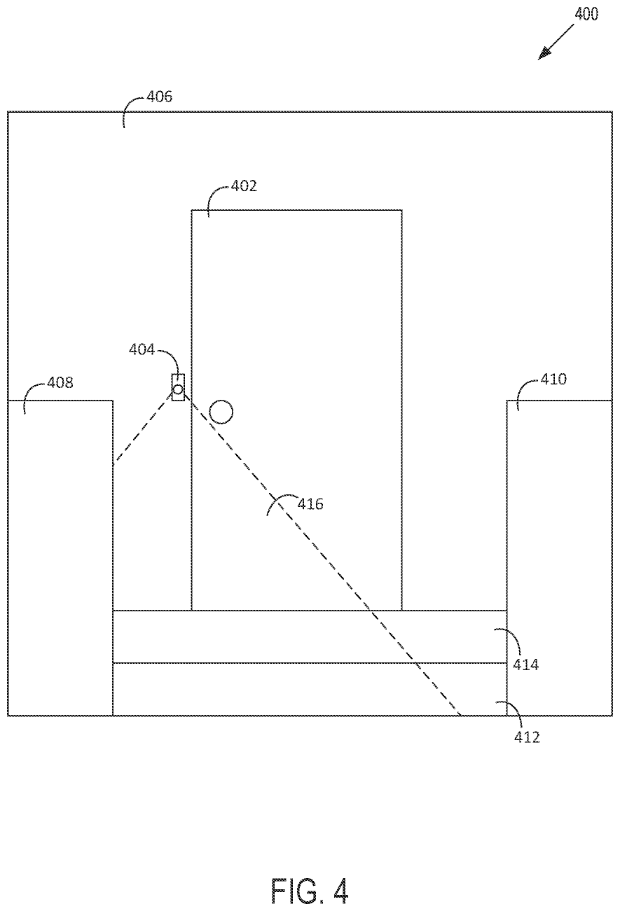

FIG. 4 is a diagram illustrating an example location 400 for delivering a package. The As shown in FIG. 4, the location 400 includes a door 402, a camera 404 affixed to an exterior wall 406, a column 408, a column 410, a step 412, and a step 414. The camera 404 has a field of view 416 that includes the steps 412 and 414 and an area between the exterior wall 406 and the column 408.

In one embodiment, the system 100 of FIG. 1 is configured to receive a request to deliver a package at a location. In this embodiment, the system 100 is configured to determine an optimal area for delivery of the package based on a maximum field of view of the location. Continuing with this embodiment, the system 100 is configured to provide an instruction for delivering the package at the optimal area.

In one example, the system 100 of FIG. 1 is configured to receive a request to deliver a package at the location 400. In one example, the request to deliver the package at the location 400 is received subsequently to an individual completing an order for an item via a website on the Internet. In another example, the request to deliver a package at the location 400 is received when an individual provides a package to a delivery company. In another example, the request to deliver the package at the location 400 is received when an individual places an order via a mobile device (e.g., UE 109 of FIG. 1).

In one example, the system 100 of FIG. 1 is configured to determine an optimal location for delivery of the package based on a maximum field of view of the location 400. In one example, the field of view of the location may be based on a perspective from one or more buildings at the location. In another example, the field of view of the location may be based on the field of view of on interior area of a location. For example, the maximum field of view may be a particular perspective of a lobby or a hallway of a building. In one example, the field of view is based on the field of view of a camera affixed to a building at the location. For example, the system 100 is configured to determine one or more characteristics of the camera 404 and further determine the corresponding field of view 416 of the camera 400.

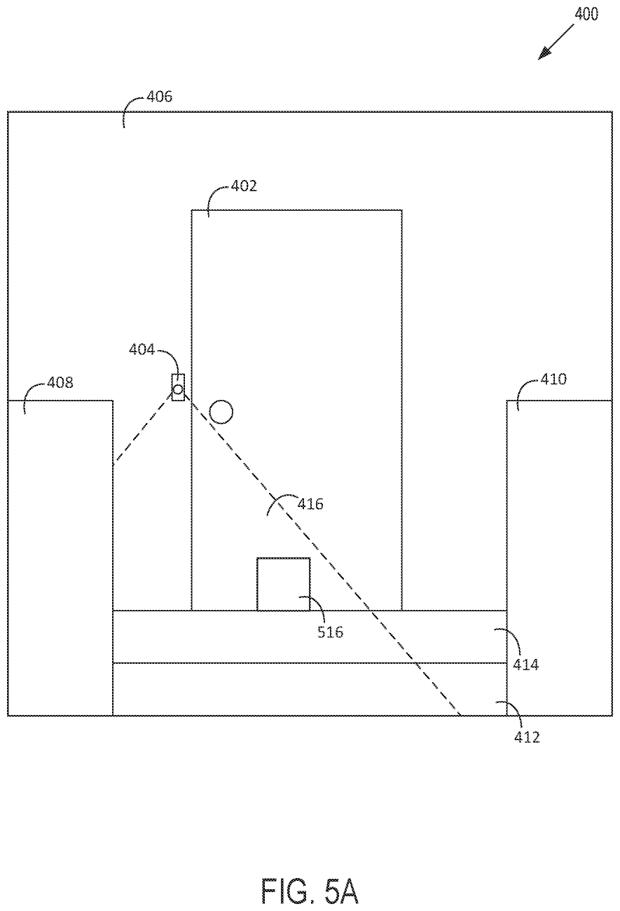

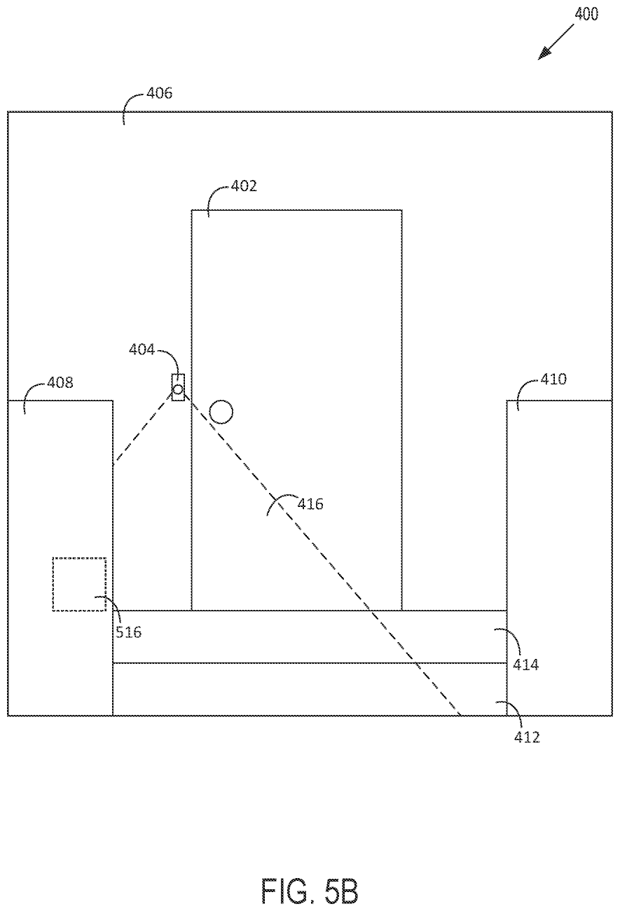

FIG. 5A is an example scenario for determining an optimal area for delivery of a package at the location 400 of FIG. 4. FIG. 5A includes the placement of a package 516 at the location 400. In one example, the system of FIG. 1 is configured to determine the optimal location for delivery of the package at the location 400 as shown in FIG. 5A. In this example, the system 100 is configured to determine that an area centered in front of the door 402 is the optimal location for the delivery of the package. Continuing with this example, the system 100 is configured to determine that the area associated with the package 516 is included in the maximum field of view of the camera 404. Further, the system 100 is configured to provide an instruction for delivering the package at the optimal area as shown in FIG. 5A.

In one embodiment, the system 100 is configured to receive one or more temporal elements associated with the location 400 and determine the optimal area based on the maximum field of view of the camera 404 and the one or more temporal elements. For example, the one or more temporal elements may include information pertaining to the schedule of an occupant associated with the location 400. In this example, the schedule may indicate that the occupant is home when placing the package 516. Continuing with this example, the system 100 is configured to determine the optima area based on the maximum field of view of the camera 404 and the schedule of the occupant, as shown in FIG. 5A.

FIG. 5B is another example scenario for determining an optimal area for delivery of a package at the location 400 of FIG. 4. FIG. 5B includes the placement of a package 516 at the location 400. In one example, the system 100 of FIG. 1 is configured to determine the optimal area for delivery of the package at the location 400. In this example, the system 100 is configured to determine that an area between the exterior wall 406 and the column 408 is the optimal location for the delivery of the package. Continuing with this example, the system 100 is configured to determine that the area between the exterior wall 406 and the column 408 is still in the maximum field of view of the camera 404.

In one embodiment, the system 100 is configured to receive a notification corresponding to the optimal area as shown in FIG. 5A. In this embodiment, the system 100 is configured to, based on the notification, determine the revised optimal area as shown in FIG. 5B. Continuing with this embodiment, the system 100 is configured to provide an instruction for placing the package 516 at the revised optimal area between the exterior wall 406 and the column 408 as shown in FIG. 5B.

In one example, the notification may include information pertaining to one or more changes to a work schedule associated with an occupant of the location 400 and therefore cause the package to sit outside the location 400 for longer than originally expected. In another example, the notification may include information pertaining to weather data associated with the location. For example, a storm approaching the location 400 may cause the package 516 to be damaged based on exposure to the storm. In one example, the system 100 may send the instruction to a drone to move the package 516 to the revised optimal location, as shown in FIG. 5B, based on the expected effects of the storm.

In another example, the notification may include information pertaining to event data associated with the location. The event data may include when a particular geographic area associated including the location 400 will be participating in an annual celebration. In one example, the annual celebration may cause an increase in the number of pedestrians outside the location 400. In this example, the system 100 may be configured to determine, based on the maximum field of view of the camera 404 and the start and end times associated with the annual celebration, the optimal area for delivery of the package 516 as shown in FIG. 5B.

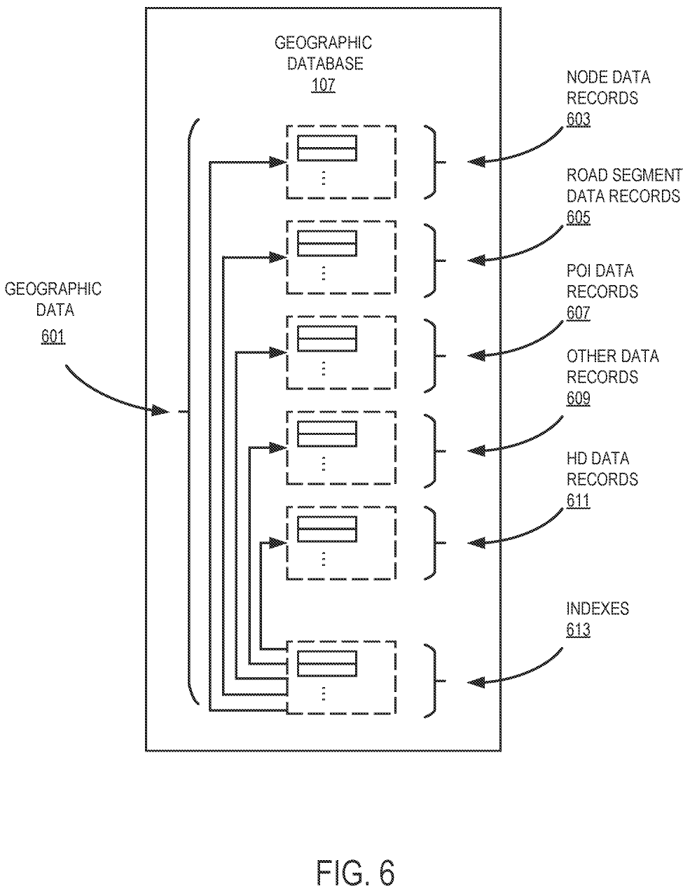

FIG. 6 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 601 used for (or configured to be compiled to be used for) mapping and/or navigation-related services, such as for personalized route determination, according to exemplary embodiments. For example, the geographic database 107 includes node data records 603, road segment data records 605, POI data records 607, other data records 609, HD data records 611, and indexes 613, for example. It is envisioned that more, fewer or different data records can be provided.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”) — A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 605 are links or segments representing roads, streets, or paths, as can be used in the calculated route or recorded route information for determination of one or more personalized routes, according to exemplary embodiments. The node data records 603 are end points or vertices (such as intersections) corresponding to the respective links or segments of the road segment data records 605. The road segment data records 605 and the node data records 603 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 607. In one example, the POI data records 607 may include the hours of operation for various businesses. The geographic database 107 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, other data records 609 include cartographic (“carto”) data records, routing data, delivery data, weather data, and maneuver data. In one example, the other data records 609 include data that is associated with certain POIs, roads, or geographic areas. In one example, the data is stored for utilization by a third-party. In one embodiment, the other data records 609 include traffic data records such as traffic data reports. In one example, the traffic data reports are based on historical data. In another example, the traffic data reports are based on real-time traffic data reports. In one embodiment, the other data records 609 include event data. In one example, the event data includes information about upcoming events such as start time, end time, impact to access to one or more road segments, etc. In one embodiment, the other data records 609 include weather data records such as weather data reports. For example, the weather data records can be associated with any of the map features stored in the geographic database 107 (e.g., a specific road or link, node, intersection, area, POI, etc.) on which the weather data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example. In another embodiment, the other data records 609 include delivery data records. In one example, the delivery data records include optimal areas for placement of packages. In another example, the delivery data records may be based on various elements of map data. In another example, the delivery data records may be based on traffic data, weather data, event data, or combination thereof.

In one embodiment, the geographic database 107 may also include point data records for storing the point data, map features, as well as other related data used according to the various embodiments described herein. In addition, the point data records can also store ground truth training and evaluation data, machine learning models, annotated observations, and/or any other data. By way of example, the point data records can be associated with one or more of the node data records 603, road segment data records 605, and/or POI data records 607 to support verification, localization or visual odometry based on the features stored therein and the corresponding estimated quality of the features. In this way, the point data records can also be associated with or used to classify the characteristics or metadata of the corresponding records 603, 605, and/or 607.

As discussed above, the HD data records 611 may include models of road surfaces and other map features to centimeter-level or better accuracy. The HD data records 611 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 611 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 611 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 611.

In one embodiment, the HD data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The indexes 613 in FIG. 6 may be used improve the speed of data retrieval operations in the geographic database 107. Specifically, the indexes 613 may be used to quickly locate data without having to search every row in the geographic database 107 every time it is accessed. For example, in one embodiment, the indexes 613 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

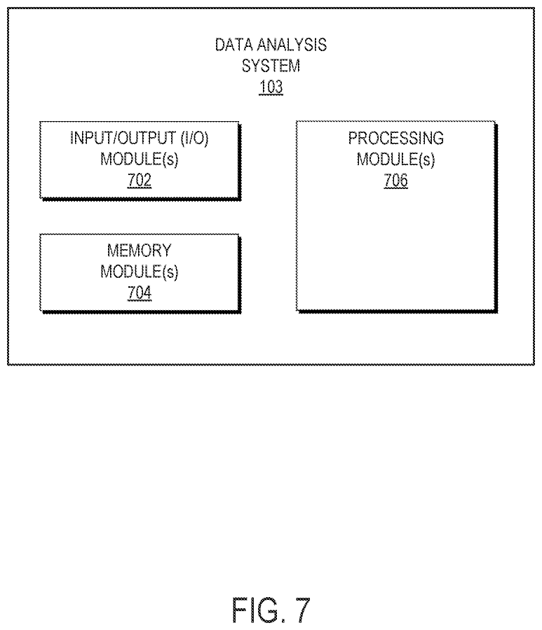

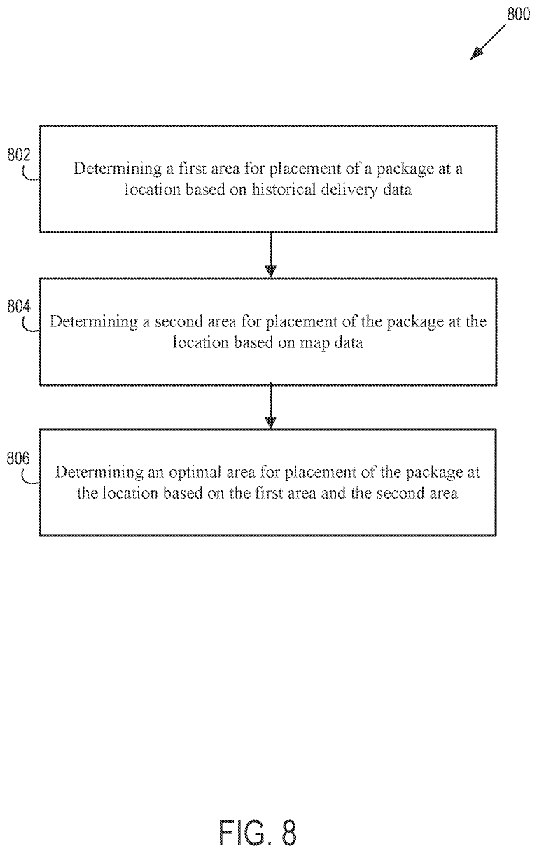

FIG. 7 is a diagram of the components of the data analysis system 103 of FIG. 1, according to one embodiment. By way of example, the data analysis system 103 includes one or more components for determining an optimal placement of a package at a location according to the various embodiments described herein. It is contemplated that the functions of these components may be combined or performed by other components of equivalent functionality. In this embodiment, data analysis system 103 includes in input/output module 702, a memory module 704, and a processing module 706. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 702-706 may be implemented as a cloud-based service, local service, native application, or combination thereof. The functions of these modules are discussed with respect to FIGS. 8, 9, and 10 below.

FIGS. 8, 9, and 10 are flowcharts of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 8, 9, and 10 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 8, 9, and 10 may represent circuitry that is wired to perform the specific logical functions in the process. Illustrative methods, such as those shown in FIGS. 8, 9, and 10, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 8, 9, and 10 may be fully performed by a computing device (or components of a computing device such as one or more processors) or may be distributed across multiple components of the computing device, across multiple computing devices, and/or across a server.

Referring first to FIG. 8, an example method 800 may include one or more operations, functions, or actions as illustrated by blocks 802-806. The blocks 802-806 may be repeated periodically or performed intermittently, or as prompted by a user, device, or system. In one embodiment, the method 800 is implemented in whole or in part by the data analysis system 103 of FIG. 7.

As shown by block 802, the method 800 includes determining a first area for placement of a package at a location based on historical delivery data. In one example, the input/output module 702 of FIG. 7 is configured to determine a first area for placement of a package at a location based on historical delivery data. In one example, the historical delivery data is stored in the memory module(s) 704 of FIG. 7. In one example, the historical delivery data may include one or more designated areas by an individual associated with the location. For example, the individual may designate an area (e.g., in front of the garage) for packages over a certain size and/or weight.

As shown by block 804, the method 800 also includes determining a second area for placement of the package at the location based on map data. In one example, the processing module 706 of FIG. 7 is configured to determine a second area for placement of the package at the location based on map data. In one example, determining the second area for placement of the package at the location based on map data includes an analysis of a layout of one or more road segments. In one scenario, the map data is used to determine the area for placement of a package at a residential home located on a street that has no outlet. In this scenario, the processing module 706 is configured to determine that there is a lower probability of individuals driving down a street that has no outlet and therefore use that as a factor in determining the optimal area for placement of the package. In another scenario, the map data is used to determine the area for placement of a package at another residential home located on a street that is in front of a school. In this scenario, the processing module 706 is configured to determine that there is a higher probability of pedestrians during the hours associated with the opening and closing of the school and therefore use that as a factor in determining the optimal area for placement of the package.

In one embodiment, the method 800 also includes receiving traffic data associated with the location. In this embodiment, the method 800 also includes based on the map data and the traffic data, determining the second area for placement of the package. In one example, the traffic data may be based on historical traffic data, real-time traffic data, or a combination thereof. In one example, the processing module 706 of FIG. 7 is configured to utilize the traffic data and the map data in determining the second area for placement of the package at the location.

In another embodiment, the method 800 also includes receiving weather data associated with the location. In this embodiment, the method 800 also includes based on the map data and the weather data, determining the second area for placement of the package. In one example, the weather data may include weather data reports at various times throughout the day. In one example, the processing module 706 of FIG. 7 is configured to utilize the weather data and the map data in determining the second area for placement of the package at the location.

In another embodiment, the method 800 also includes receiving event data associated with the location. In this embodiment, the method 800 also includes based on the map data and the event data, determining the second area for placement of the package. In one example, the event data may include a schedule of upcoming concerts associated with one or more venues nearby the location. In another example, the event data may include a schedule of sporting events associated with one or more professional sports arena nearby the location. In one example, the processing module 706 of FIG. 7 is configured to utilize the event data and the map data in determining the second area for placement of the package at the location.

In one embodiment, the method 800 also includes determining a field of view of a camera affixed to a building at the location. In this embodiment, the method 800 also includes based on the map data and the determined field of view, determining the second area for placement of the package. In one example, the processing module 706 of FIG. 7 is configured to receive camera information (e.g., field of view, model information, images sensor capabilities, etc.) from a resident of a home. In another example, the processing module 706 is configured to receive camera information from one or more residential or commercial security service providers associated with operation of the camera. In one example, the processing module 706 may be configured to determine the field of view of a camera affixed to a building at the location based on an analysis of images of the location that include the camera.

In one embodiment, the method 800 also includes determining the second area for placement of the package at the location based on the map data and one or more temporal elements. In one example, the processing module 706 of FIG. 7 is configured to determine the second area for placement of the package at the location based on the map data and the one or more temporal elements. In one example, the one or more temporal elements include the hours of operation associated with a particular business. In one example, the one or more temporal elements include a schedule of “no parking” along a particular side of the street. In another example, the one or more temporal elements include the hours corresponding to the beginning and the end of a school day. For instance, if a package is being delivered by a drone to home that is adjacent to a school, then the drone may be instructed to deliver the package in the back of the house if it during a time that students are leaving the school.

As shown by block 806, the method 800 also includes determining an optimal area for placement of the package at the location based on the first area and the second area. In one example, the processing module 706 of FIG. 7 is configured to determine an optimal area for placement of the package at the location based on the first area and the second area. In one example, the processing module 706 is configured to analyze one or more aspects associated with the location, the first area, and the second area in determining the optimal area for placement of the package at the location. In one example, the one or more aspects may be based on historical information or real-time information. In another example, the one or more aspects may be based on map data (e.g., stop signs, directions of traffic, proximity to points of interest, etc.) associated with the location, the first area, and the second area.

In one embodiment, the method 800 also includes receiving a notification corresponding to the determined optimal area. In this embodiment, the method 800 also includes based on the notification, determining a revised optimal area for placement of the package. Continuing with this embodiment, the method 800 also includes providing an instruction for moving the package to the revised optimal area. In one example, the notification is received by the processing module 706 of FIG. 7 via the input/output module 702 of FIG. 7. In this example, the processing module 706 is configured to determine a revised optimal area for placement of the package based on the received notification.

In one embodiment, the method 800 also includes mapping the determined optimal area for placement of a package onto one or more map data layers of a high-definition map to provide one or more instructions for delivery of packages in the future. In one embodiment, the method 800 also includes linking the determined optimal area for placement of a package with one or more portions, components, areas, layers, features, text, symbols, and/or data records of a map (e.g., an HD map).

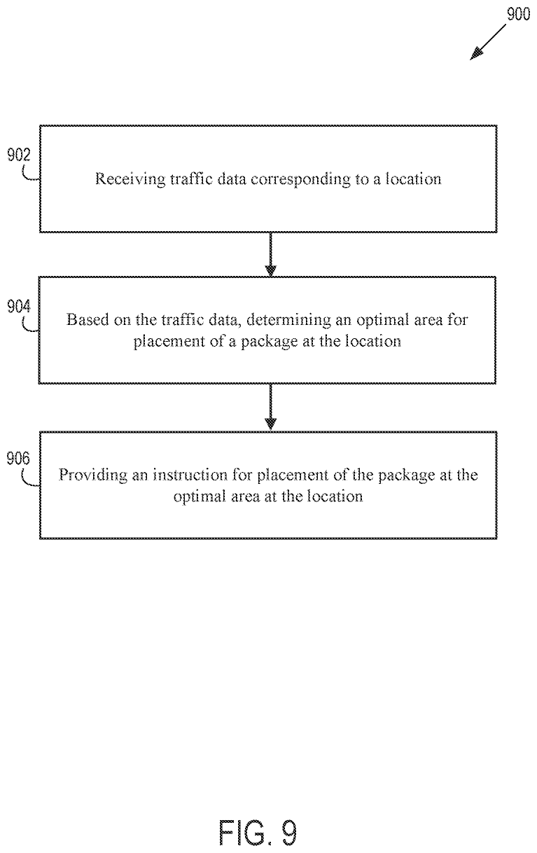

Referring to FIG. 9, the example method 900 may include one or more operations, functions, or actions as illustrated by blocks 902-906. The blocks 902-906 may be repeated periodically or performed intermittently, or as prompted by a user, device, or system. In one embodiment, the method 900 is implemented in whole or in part by the data analysis system 103 of FIG. 7.

As shown by block 902, the method 900 includes receiving traffic data corresponding to a location. In one example, the processing module 706 of FIG. 7 is configured to receive, via the input/output module 702 of FIG. 7, traffic data corresponding to a location. In one example, the traffic data includes real-time traffic data reports. In another example, the traffic data includes historical traffic data.

As shown by block 904, the method 900 also includes based on the traffic data, determining an optimal area for placement of a package at the location. In one example, the processing module 706 of FIG. 7 is configured to, based on the traffic data, determine an optimal area for placement of a package at the location. In one example, the optimal placement of a package is an area that avoids a line of sight of the package based on a direction of traffic.

In one embodiment, the method 900 also includes receiving weather data associated with the location. In this embodiment, the method 900 also includes based on the traffic data and the weather data, determining the optimal area for placement of the package at the location. In one example, the weather data includes real-time weather data reports. In one example, the processing module 706 of FIG. 7 is configured to receive, via the input/output module 702 of FIG. 7, weather data associated with the location. In this example, the processing module 706 is configured to, based on the traffic data and the weather data, determine the optimal area for placement of the package at the location.

In another embodiment, the method 900 also includes receiving event data associated with the location. In this embodiment, the method 900 also includes based on the traffic data and the event data, determining the optimal area for placement of the package at the location. In one example, the processing module 706 of FIG. 7 is configured to receive, via the input/output module 702 of FIG. 7, event data associated with the location. In this example, the processing module 706 is configured to, based on the traffic data and the event data, determine the optimal area for placement of the package at the location. In one example, the event data includes information about one or more routes affected (e.g., street closures) by a particular event.

In one embodiment, the method 900 also includes determining a field of view of a camera affixed to a building at the location. In this embodiment, the method 900 also includes based on traffic data and the determined field of view, determine the optimal area for placement of the package. In one example, the field of view of the camera affixed to the building may be determined based on the position of the camera and one or more elements associated with the location. In one example, the processing module 706 of FIG. 7 is configured to determine a field of view of a camera affixed to a building at the location. In this example, the processing module 706 is configured to, based on the traffic data and the determined field of view, determine the optimal area for placement of the package.

In one embodiment, the method 900 also includes determining the second area for placement of the package at the location based on the map data and one or more temporal elements. In one example, the one or more temporal elements include one or more periods of time throughout the week associated with a higher likelihood of pedestrian activity at one or more locations. In one example, the processing module 706 of FIG. 7 is configured to determine the second area for placement of the package at the location based on the map data and one or more temporal elements.

As shown by block 906, the method 900 also includes providing an instruction for placement of the package at the optimal area at the location. In one example, the instruction for placement of the package includes an instruction for providing a visual overlay on a user interface. In this example, the user interface is configured to provide real-time feedback on whether the package has been placed in the optimal area. In one example, the user-interface is part of an application (e.g., application(s) 117 of FIG. 1) on a portable electronic device (e.g., UE 109 of FIG. 1). In one example, the processing module 706 of FIG. 7 is configured to provide an instruction for placement of the package at the optimal area at the location via the input/output module 702 of FIG. 7.

In one embodiment, the method 900 also includes receiving a notification corresponding to the determined optimal area. In this embodiment, the method 900 also includes based on the notification, determining a revised optimal area. Continuing with this embodiment, the method 900 also includes providing an instruction for moving the package to the revised optimal area. In one example, the processing module 706 of FIG. 7 is configured to receive, via the input/output module 702 of FIG. 7, a notification corresponding to the determined optimal area. In this example, the processing module 706 of FIG. 7 is configured to, based on the notification, determine a revised optimal area. Continuing with this example, the processing module 706 is configured to provide, via the input/output module 702, an instruction for moving the package to the revised optimal area.

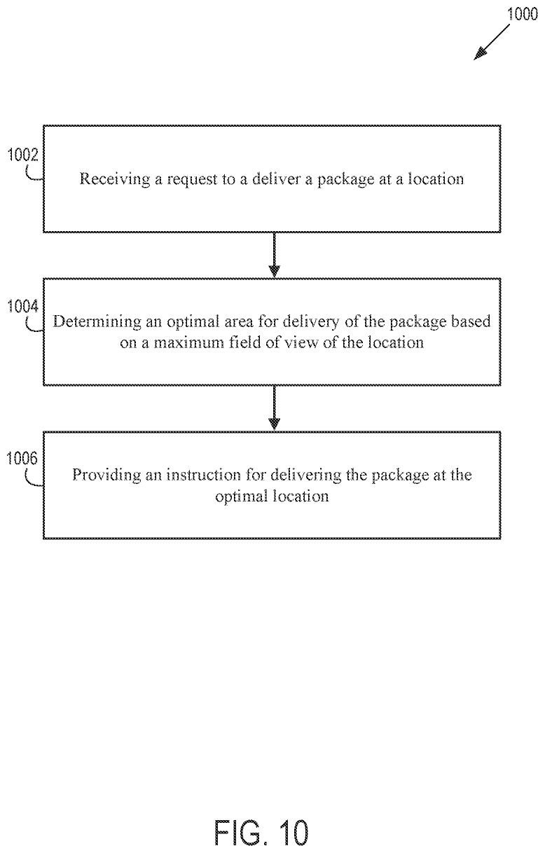

Referring to FIG. 10, the example method 1000 may include one or more operations, functions, or actions as illustrated by blocks 1002-1006. The blocks 1002-1006 may be repeated periodically or performed intermittently, or as prompted by a user, device, or system. In one embodiment, the method 1000 is implemented in whole or in part by the data analysis system 103 of FIG. 7.

As shown by block 1002, the method 1000 includes receiving a request to a deliver a package at a location. In one example, the request to deliver the package at the location includes instructions for delivery of the package. In one example, the processing module 706 of FIG. 7 is configured to receive a request to a deliver a package at a location.

As shown by block 1004, the method 1000 also includes determining an optimal area for delivery of the package based on a maximum field of view of the location. In one example, the processing module 706 of FIG. 7 is configured to determine an optimal area for delivery of the package based on a maximum field of view of the location. In one example, the maximum field of view of the location is based on a maximum field of view of a camera affixed to a building at the location.

In one embodiment, the method 1000 also includes receiving traffic data associated with the location. In this embodiment, the method 1000 also includes based on the maximum field of view of the location and the traffic data, determining the optimal area for delivery of the package. In one example, the processing module 706 of FIG. 7 is configured to receive traffic data associated with the location. In this example, the processing module 706 is configured to, based on the maximum field of view of the location and the traffic data, determine the optimal area for delivery of the package.

In another embodiment, the method 1000 also includes receiving weather data associated with the location. In this embodiment, the method 1000 also includes based on the maximum field of view of the location and the weather data, determining the optimal area for delivery of the package. In one example, the processing module 706 of FIG. 7 is configured to receive weather data associated with the location. In this example, the processing module 706 is configured to, based on the maximum field of view of the location and the weather data, determining the optimal area for delivery of the package.

In one embodiment, the method 1000 also includes receiving event data associated with the location. In this embodiment, the method 1000 also includes based on the maximum field of view of the location and the event data, determining the optimal area for delivery of the package. In one example, the processing module 706 of FIG. 7 is configured to receive event data associated with the location. In this example, the processing module 706 of is configured to, based on the maximum field of view of the location and the event data, determining the optimal area for delivery of the package.

In another embodiment, the method 1000 also includes determining the optimal area based on the maximum field of view and one or more temporal elements. In one example, the processing module 706 of FIG. 7 is configured to determine the optimal area based on the maximum field of view and one or more temporal elements.

As shown by block 1006, the method 1000 also includes providing an instruction for delivering the package at the optimal location. In one example, the processing module 706 of FIG. 7 is configured to provide an instruction for delivering the package at the optimal location via the input/output module 702 of FIG. 7. Block 1006 may be similar in functionality to block 906 of method 900.

In one embodiment, the method 1000 also includes receiving a notification corresponding to the determined optimal area. In this embodiment, the method 1000 also includes based on the notification, determining a revised optimal area. Continuing with this embodiment, the method 1000 also includes providing an instruction for placing the package at the revised optimal area. In one example, the processing module 706 of FIG. 7 is configured to receive, via the input/output module 702 of FIG. 7, a notification corresponding to the determined optimal area. In this example, the processing module 706 is configured to, based on the notification, determine a revised optimal area. Continuing with this example, the processing module 706 of FIG. 7 is configured to provide, via the input/output module 702, an instruction for moving the package to the revised optimal area.

The processes described herein for determining an optimal placement of a package at a location may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

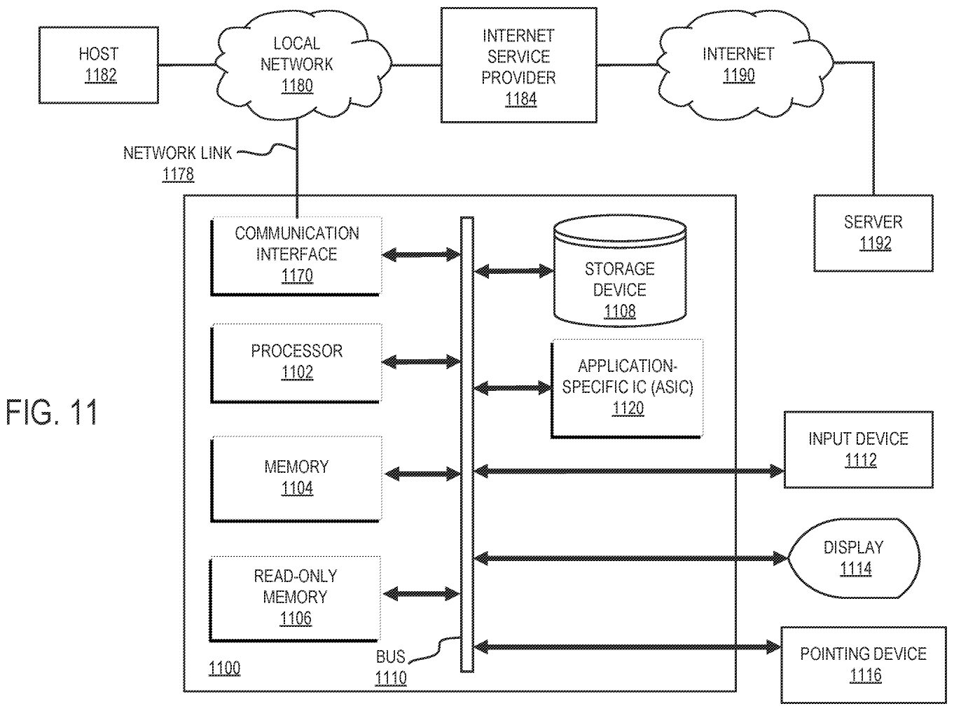

FIG. 11 illustrates a computer system 1100 upon which an embodiment may be implemented. Computer system 1100 is programmed (e.g., via computer program code or instructions) to provide information for determining an optimal placement of a package at a location as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to determining an optimal placement of a package at a location. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random-access memory (RAM) or other dynamic storage device, stores information including processor instructions for determining an optimal placement of a package at a location. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for determining an optimal placement of a package at a location, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in the computer system 1100. Other external devices coupled to bus 1110, used primarily for interacting with humans, include a display 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1100 may also include one or more instances of a communications interface 1170 coupled to bus 1110. The communication interface 1170 may provide a one-way or two-way communication coupling to a variety of external devices that operate with their own processors, such as printers, scanners and external disks. In addition, the communication interface 1170 may provide a coupling to a local network 1180, by way of a network link 1178. The local network 1180 may provide access to a variety of external devices and systems, each having their own processors and other hardware. For example, the local network 1180 may provide access to a host 1182, or an internet service provider 1184, or both, as shown in FIG. 11. The internet service provider 1184 may then provide access to the Internet 1190, in communication with various other servers 1192.

The computer system 1100 also includes one or more instances of a communication interface 1170 coupled to bus 1110. Communication interface 1170 provides a one-way or two-way communication coupling to a variety of external devices that operate with their own processors, such as printers, scanners and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, the communication interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, the communication interface 1170 may be a local area network (LAN) card to provide a data communication connection to a compatible LAN, such as Ethernet. Wireless links may also be implemented. For wireless links, the communication interface 1170 sends or receives or both sends and receives electrical, acoustic or electromagnetic signals, including infrared and optical signals, that carry information streams, such as digital data. For example, in wireless handheld devices, such as mobile telephones like cell phones, the communication interface 1170 includes a radio band electromagnetic transmitter and receiver called a radio transceiver. In certain embodiments, the communication interface 1170 enables connection to the communication network 115 of FIG. 1 for providing information for determining an optimal placement of a package at a location.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

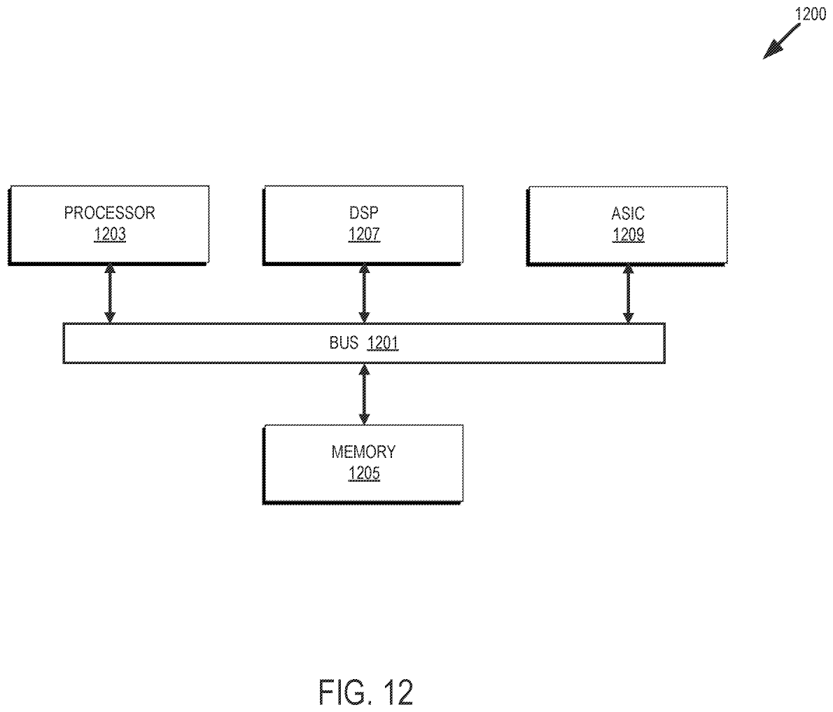

FIG. 12 illustrates a chip set 1200 upon which an embodiment may be implemented. The chip set 1200 is programmed to determine an optimal placement of a package at a location as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the steps described herein to provide information for determining an optimal placement of a package at a location. The memory 1205 also stores the data associated with or generated by the execution of the inventive steps.

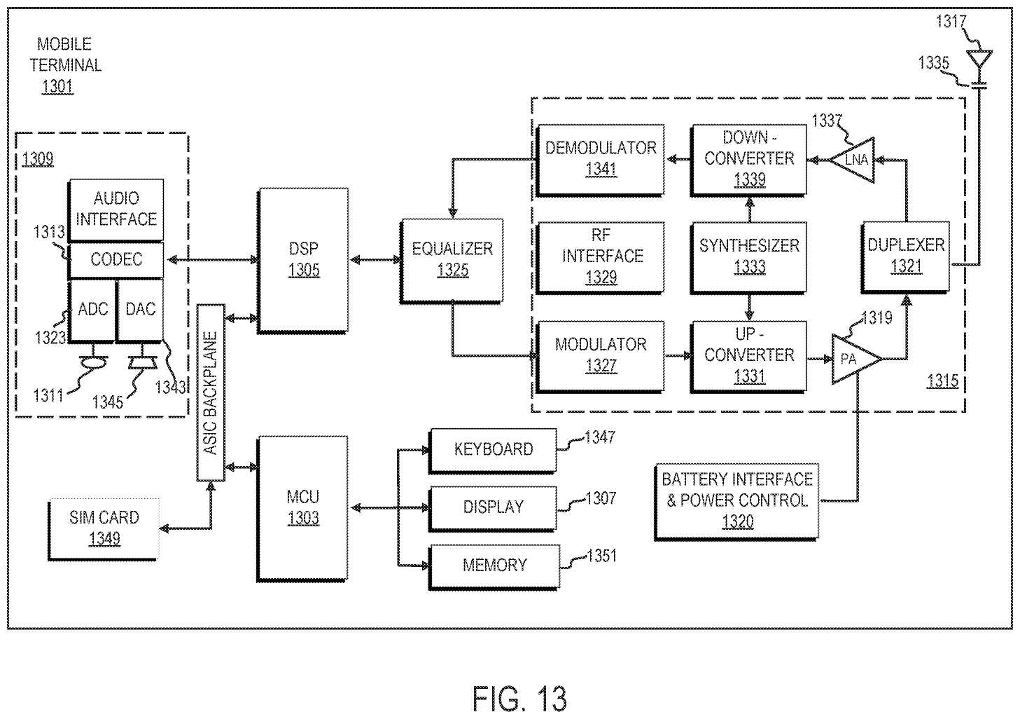

FIG. 13 is a diagram of exemplary components of a mobile terminal 1301 (e.g., a mobile device, vehicle, drone, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide information for determining an optimal placement of a package at a location. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The SIM card 1349 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

1. A method for determining an optimal placement of a package at a location, the method comprising:
determining a first area for placement of a package at a location based on historical delivery data;
determining a second area for placement of the package at the location based on map data; and
determining an optimal area for placement of the package at the location based on the first area and the second area.

2. The method of claim 1, wherein determining the second area for placement of the package further comprises:
receiving traffic data associated with the location; and
based on the map data and the traffic data, determining the second area for placement of the package.

3. The method of claim 1, wherein determining the second area for placement of the package further comprises:
receiving weather data associated with the location; and
based on the map data and the weather data, determining the second area for placement of the package.

4. The method of claim 1, wherein determining the second area for placement of the package further comprises:
receiving event data associated with the location; and
based on the map data and the event data, determining the second area for placement of the package.

5. The method of claim 1, wherein determining the second area for placement of the package includes determining the second area for placement of the package at the location based on the map data and one or more temporal elements.

6. The method of claim 1, further comprising:
receiving a notification corresponding to the determined optimal area;
based on the notification, determining a revised optimal area; and
providing an instruction for moving the package to the revised optimal area.

7. The method of claim 1, wherein determining the second area for placement of the package further comprises:
determining a field of view of a camera affixed to a building at the location; and
based on the map data and the determined field of view, determining the second area for placement of the package.

8. An apparatus comprising:
a processor; and
a memory comprising computer program code for one or more programs, wherein
the computer program code is configured to cause the processor of the apparatus to:
receive traffic data corresponding to a location;
based on the traffic data, determine an optimal area for placement of a package at the location; and
provide an instruction for placement of the package at the optimal area at the location.

9. The apparatus of claim 8, wherein the computer program code is configured to cause the processor of the apparatus to, based on the traffic data, determine the optimal area for placement of the package at the location and is further configured to cause the processor of the apparatus to:
receive weather data associated with the location; and
based on the traffic data and the weather data, determine the optimal area for placement of the package at the location.

10. The apparatus of claim 8, wherein the computer program code is configured to cause the processor of the apparatus to, based on the traffic data, determine the optimal area for placement of the package at the location and is further configured to cause the processor of the apparatus to:
receive event data associated with the location; and
based on the traffic data and the event data, determine the optimal area for placement of the package at the location.

11. The apparatus of claim 8, wherein the computer program code is further configured to cause the processor of the apparatus to:
receive a notification corresponding to the determined optimal area;
based on the notification, determine a revised optimal area; and
provide an instruction for moving the package to the revised optimal area.

12. The apparatus of claim 8, wherein the computer program code is configured to cause the processor of the apparatus to, based on the traffic data, determine the optimal area for placement of the package at the location and is further configured to cause the processor of the apparatus to:
determine a field of view of a camera affixed to a building at the location; and
based on traffic data and the determined field of view, determine the optimal area for placement of the package.

13. The apparatus of claim 8, wherein the computer program code is configured to cause the processor of the apparatus to determine a second area for placement of the package and is further configured to cause the processor of the apparatus to determine the second area for placement of the package at the location based on the map data and one or more temporal elements.

14. A non-transitory computer-readable storage medium comprising one or more sequences of one or more instructions for execution by one or more processors of a device, the one or more instructions which, when executed by the one or more processors, cause the device to:
receive a request to a deliver a package at a location;
determine an optimal area for delivery of the package based on a maximum field of view of the location; and
provide an instruction for delivering the package at the optimal location.

15. The non-transitory computer-readable storage medium of claim 14, wherein the maximum field of view of the location is based on maximum field of view of a camera affixed to a building at the location.

16. The non-transitory computer-readable storage medium of claim 14, wherein the one or more instructions which, when executed by the one or more processors, cause the device to determine an optimal area for delivery of the package based on the maximum field of view further cause the device to:
receive traffic data associated with the location; and
based on the maximum field of view of the location and the traffic data, determine the optimal area for delivery of the package.

17. The non-transitory computer-readable storage medium of claim 14, wherein the one or more instructions which, when executed by the one or more processors, cause the device to determine an optimal area for delivery of the package based on the maximum field of view further cause the device to:
receive weather data associated with the location; and
based on the maximum field of view of the location and the weather data, determine the optimal area for delivery of the package.

18. The non-transitory computer-readable storage medium of claim 14, wherein the one or more instructions which, when executed by the one or more processors, cause the device to determine an optimal location for delivery of the package based on the maximum field of view further cause the device to:
receive event data associated with the location; and
based on the maximum field of view of the location and the event data, determine the optimal area for delivery of the package.

19. The non-transitory computer-readable storage medium of claim 14, wherein the one or more instructions which, when executed by the one or more processors, cause the device to determine an optimal area for delivery of the package based on the maximum field of view of the location further cause the device to determine the optimal area based on the maximum field of view and one or more temporal elements.

20. The non-transitory computer-readable storage medium of claim 14, wherein the one or more instructions which, when executed by the one or more processors, further cause the device to:
receive a notification corresponding to the determined optimal area;
based on the notification, determine a revised optimal area; and
provide an instruction for placing the package at the revised optimal area.
